(19) United States
(12) Patent Application Publication
(10) Pub. No.: US 2026/0279391 A1
(43) Pub. Date: Sep. 17, 2026

(54) SELF-LUBRICATING GUIDE RAIL ARRANGMENT FOR LINEAR ACTUATORS

(71) Applicant: Seagate Technology LLC, Fremont, CA (US)

(72) Inventors: Michael Yi Zhao Yao, Singapore (SG); Lihong Zhang, Singapore (SG); Daniel Raymond Stevens, Longmont, CA (US); Tsuny Ming Boh, Singapore (SG); Barish Chakravarty, Singapore (SG); Xiong Liu, Singapore (SG)

(21) Appl. No.: 19/081,701

(22) Filed: Mar. 17, 2025

(51) Int. Cl. G11B 5/48; F16N 1/00

(52) U.S. Cl. CPC G11B 5/4833; F16N 1/00; G11B 5/4813

(57) ABSTRACT

Described are linear actuators the include plain bearing linear rails whose sliding interfaces are made up of a self-lubricating polymer surface on one side and a stainless steel surface on the other. Such a configuration lowers wear and friction without the use of grease or other such organic lubricants that may produce contaminants inside controlled environments such as sealed enclosure hard disk drives. The self-lubricating polymer of the described linear rails may be provided as a sandwiched layer or top coating layer bound by a metal architecture, preferably stainless steel. The self-lubricating polymer may be polyoxymethylene (POM), polyamide (Nylon), polyether ether ketone (PEEK) or combinations thereof.

The present disclosure generally relates to linear actuator rails, particularly for use in hard disk drives.

### SUMMARY

Methods and devices of the present disclosure relate to plain bearing linear rails in which the sliding interface includes a self-lubricating polymer surface in sliding contact with a stainless steel surface.

In certain aspects, the present disclosure provides hard disk drives for recording data on a spinning magnetic media disk using a recording head suspended on the end of an actuator arm, in which the hard disk drives include a plain bearing linear rail system having a carriage slidably movable on a linear rail, thereby forming a sliding interface between the carriage and the linear rail. The sliding interface has a self-lubricating polymer surface in sliding contact with a stainless steel surface. The actuator arm is coupled to the carriage such that movement of the carriage along the linear rail moves the actuator arm in a linear fashion.

In certain aspects, the self-lubricating polymer is POM, Nylon, PEEK, or combinations thereof. In certain aspects, either or both of the self-lubricating polymer and the stainless steel may include a solid lubricant additive such as graphite, molybdenum disulfide, polytetrafluoroethylene, zinc oxide, or combinations thereof.

For each sliding interface, the self-lubricating polymer surface may be provided on the linear rail or on the carriage, with the stainless steel surface being correspondingly provided on the carriage or the linear rail.

In certain aspects, the plain bearing linear rail system includes a motor configured to move the carriage along the linear rail. The motor may be, for example, a voice coil motor, a piezoelectric motor, or an ultrasonic motor. The plain bearing linear rail system may further include one or more positional feedback sensors.

In certain aspects, the present disclosure provides linear actuators that include a plain bearing linear rail system having a carriage slidably movable on a linear rail, thereby forming a sliding interface between the carriage and the linear rail. The sliding interface is composed of a self-lubricating polymer surface in sliding contact with a stainless steel surface. The linear actuators further include a motor configured to move the carriage along the linear rail.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF THE DRAWINGS

FIG. 1 is a schematic representation of components of a hard disk drive having a linear actuation configuration for controlling the movement of the recording head.

FIG. 2A shows schematic representations of carriage and rail systems that may be used in accordance with aspects of the present disclosure.

FIG. 2B shows schematic representations of linear rails that may be used in accordance with aspects of the present disclosure.

FIG. 2C shows schematic representations of linear rails that may be used in accordance with aspects of the present disclosure.

### DETAILED DESCRIPTION

The present disclosure relates to linear actuators and to rails for use in linear actuators. In particular, the present disclosure relates to using hybrid structures made of a self-lubricating polymer and stainless steel for plain bearing (or slide bearing) linear rails to minimize wear and friction without the use of grease or other such organic lubricants that may produce contaminants inside controlled environments such as sealed enclosure hard disk drives (HDDs). Accordingly, plain bearing linear rails can be constructed from a self-lubricating polymer and stainless steel such that any sliding interface (for example an interface between a rail and a carriage) is an interface between the self-lubricating polymer on the one side and the stainless steel on the other. Without adding lubricants such as grease at the interface, the described plain bearing linear rails can achieve low friction and low wear.

The self-lubricating polymer of the described linear rails may be provided as a sandwiched layer or top coating layer bound by a metal architecture, preferably stainless steel. The self-lubricating polymer may be polyoxymethylene (POM), polyamide (Nylon), polyether ether ketone (PEEK) or combinations thereof. Plain bearing linear rails constructed in accordance with the present disclosure may have high mechanical stiffness, and linear actuator motors that incorporate such linear rails may exhibit low power consumption. Moreover, the grease-free interface can reduce sources of outgassed contamination, thus allowing the described linear rails to be employed in linear actuators used for clean applications such as inside sealed enclosure HDDs.

Linear rails and actuators in accordance with the present disclosure represent an advance over prior construction that include grease or other lubricants, that use ceramic coatings or PTFE coatings to improve the durability of the linear rail bearing, or that use contactless techniques like magnetic or ultrasonic levitation. Grease and other lubricants can add undesired organic contaminants, particularly in a controlled atmosphere environment like a sealed enclosure HDD. Ceramic coatings can generate abrasive particle debris that is undesirable for certain applications such as inside the enclosure of an HDD. PTFE coatings are composed of PFAS materials, the use of which is heavily restricted today. Contactless levitation techniques require high power consumption to operate, which is not suitable for low power products like HDDs.

Linear rails and linear actuators have applications in many industries. In one example, linear rails and linear actuators may be used to control the movement of actuator arms in HDDs to achieve zero-skew recording. Minimizing the friction and wear of the bearing interface by using linear rail constructions in accordance with the present disclosure may significantly improve the efficiency and performance of the linear rails, which can improve the lifespan, accuracy and power consumption of the system.

Stainless steel is the main material used for the bearing surfaces of linear rails. Steel has high strength, durability and high load capability, but also has high friction and wear, and is susceptible to corrosion. In steel guide rails exhibiting surface wear, the friction can become so high that the guide rails either cannot move smoothly or cannot move at all.

Coatings and lubricants are therefore used to reduce the friction and wear. However, the coating and lubricating materials may become sources of particulate contaminants and outgas contaminants, and so are not preferred for high cleanliness products and application such as inside HDD enclosures.

In general, conventional plain linear bearings may be expected to have higher friction/wear and heat generation due to the large contact area of the sliding interface as compared to the use of ball-bearings. As such, certain plain linear bearing designs in accordance with the present discloser seek to minimize the friction and wear of the interface surfaces without using grease while providing high mechanical robustness. As mentioned, ceramic bearing materials have high friction and wear, producing particles that are hard and abrasive. Certain low-friction plastics may deform under high loads or temperatures. Diamond-like carbon and molybdenum disulfide coatings can reduce friction, but these materials have their drawbacks as well. Diamond-like carbon does not bond strongly with steel, and molybdenum disulfide may be a source of particle generation. Oils or greases like hydrocarbon oils, ester oils, perfluoropolyether oils or soap-based greases have also been used for guide rails, but are not suitable for HDDs due in part to outgassing of contamination.

In accordance with the present disclosure, self-lubricating polymers such as POM, polyamide, and PEEK can be used to form a low friction interface with stainless steel in a manner that is suitable for HDD environments. In particular, an interface composed of opposing surfaces of POM and steel provides a robust combination for tribological applications that are sensitive to friction, wear and contamination.

Reference will now be made to the drawings, which depict one or more aspects described in this disclosure. However, it will be understood that other aspects not depicted in the drawings fall within the scope of this disclosure. Like numbers used in the figures refer to like components, steps, and the like. However, it will be understood that the use of a reference character to refer to an element in a given figure is not intended to limit the element in another figure labeled with the same reference character. In addition, the use of different reference characters to refer to elements in different figures is not intended to indicate that the differently referenced elements cannot be the same or similar.

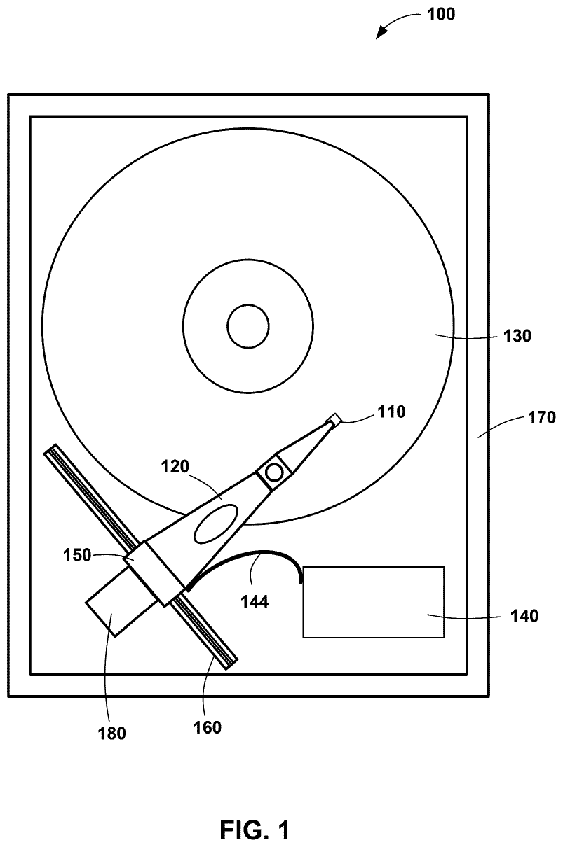

FIG. 1 schematically shows certain internal components of an HDD 100 in accordance with certain aspects of the present invention. Within the housing 170 of HDD 100 is a recording head 110 suspended over the surface of magnetic media disk 130 on the end of an actuator arm 120 that traverses media disk 130 by use of a linear rail 160 and carriage 150 system. The actuator arm 120 is coupled to a carriage 150 that moves along linear rail 160 by way of a motor 180. Motor 180 can be any suitable motor such as a voice coil motor (VCM), piezoelectric motor (such as inchworm, stepper, and slip-stick), ultrasonic motor (USM), or any other motor capable of producing linear motion. Recording head 110 is coupled to controller electronics 140 in any suitable fashion, such as the use of a flex circuit 144. In addition, motor 180 can be controlled from electronics provided on printed circuit board and that that is communicatively coupled to the controller electronics 140 via flex circuit 144 to thereby move actuator 120 by way of linear rail 150. A preamp (not shown) may be coupled recording head 110 to condition signals provided to and from the recording head 110.

While the HDD 100 in FIG. 1 is schematically shown to include a recording head 110 on the end of an actuator arm 120 that connects to a rail system located to the side of the recording disks 130, it will be appreciated that other arrangements are possible. For example, a rail system could extend over the recording disks with one or more recording heads connected to the rail system so that the one or more recording heads move on the rail system, instead of using an extended actuator arm. In such a configuration, the attachment between the slider and the rail system, or the slider itself, can be considered an actuator arm in the sense that it is what imparts motion to the recording head. Linear actuator mechanisms for hard disk drives include those described in U.S. Pat. No. 11,488,624, the disclosure of which is incorporated herein in its entirety.

It will be appreciated that various aspects of the present disclosure may be implemented in disk drive systems that include multiple (typically stacked) recording media disks, multiple recording heads whether provided as a single recording head per recording media surface, multiple recording heads per recording media surface, or in a configuration such as with an elevator-style actuator arm where there are fewer recording heads per recording media surface (such as the system disclosed in U.S. Pat. No. 11,348,611, which is incorporated by reference herein in its entirety).

In an HDD, the use of linear actuation rather than rotary actuation to move actuator arms for the traversal of recording media by recording heads eliminates the skew effects caused by rotary actuation. In conventional HDDs, circular data tracks are accessed by the recording heads mounted on supporting suspensions at the end of actuator arms that are rotated around a pivot by a VCM. The utilization of VCM rotary actuation results in the orientation of the recording head being skewed relative to the data track by an amount that depends on the location across the disk. From tracks near the inner diameter of the recording disk to tracks near the outer diameter, the skew angle can vary from −17° to +17° in a typical 3.5 inch HDD. The ability to implement linear actuation in an HDD to replace rotary actuation can eliminate such skew effects, ultimately resulting in more consistent bit sizes and higher recording densities, as well as help enable two-dimensional magnetic recording by maintaining a constant spacing and orientation between two readers relative to the recorded tracks. In accordance with the present disclosure, linear rails constructed of self-lubricating engineering plastics can help implement such linear actuation.

In accordance with various aspects of the present disclosure, any suitable linear actuator may be used to drive a plain bearing (or slide bearing) linear rail. A linear actuator is an actuator that creates linear motion, in contrast to the circular motion of a conventional motor. In certain embodiments, the linear actuators may include feedback sensors so that the positioning can be well-controlled. Feedback sensors may include potentiometers, Hall sensors, optical sensors, and the like. In certain embodiments, the linear actuator may be constructed to have enclosed components. For example, the motor and moving components can be enclosed in a jacket to minimize the expulsion of particles, aerosol, and outgassing into the surrounding environment. Moreover, multiple linear actuator types can be combined to take advantage of different features such as coarse and fine motion to improve speed as well as precision.

Linear actuators can create linear motion in various ways, including: electromechanical actuators that use electric motors, which are commonly used in robotics, medical devices, and general automation; hydraulic actuators that use pressurized hydraulic fluid, which are known for high force capabilities and often used in heavy-duty applications; pneumatic actuators that operate using compressed air, which are favored for their simplicity and speed, making them ideal for applications requiring quick and repetitive movements, piezoelectric actuators that use materials that change shape upon application of an electric field to produce precise movements, which are used in applications requiring high precision; belt-driven actuators that use a tensioned belt to drive linear motion, which are used in high-speed, low-load applications; screw-driven actuators that use a lead screw or ball screw to convert rotational motion into linear motion, which are preferred for applications requiring high accuracy over short travel distances; rack and pinion actuators that employ a gear rack and a pinion gear to convert rotational motion into linear motion, which are used in applications where precise positioning and high force are needed; and linear voice coil actuators that use a voice coil motor to drive linear motion, which offer extremely precise positioning and control. In certain

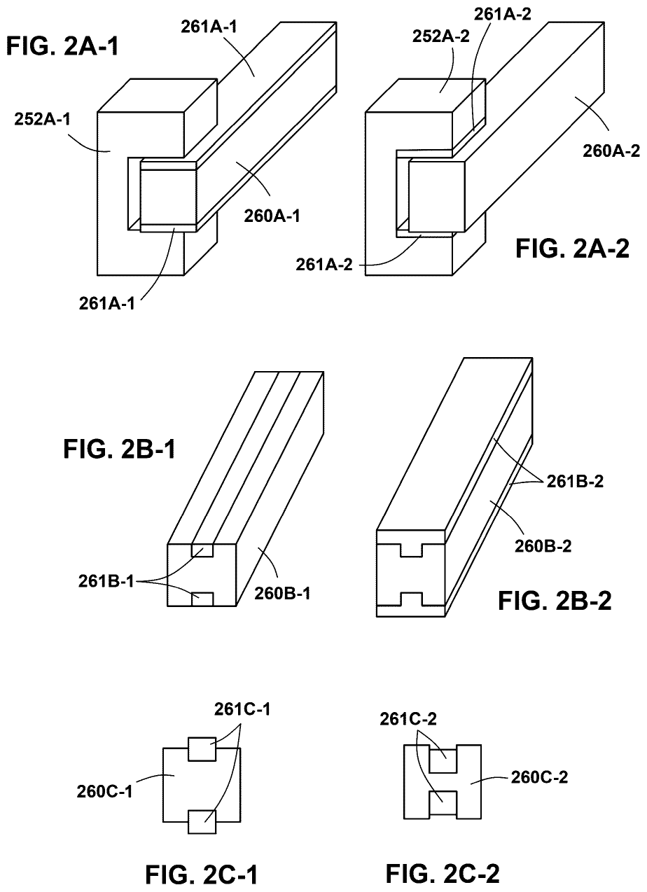

FIGS. 2A-1 and 2A-2 schematically show linear rails systems in accordance with certain aspects of the present disclosure. In FIG. 2A-1, the linear rail is composed of a metal core 260A-1 having top and bottom surfaces formed from a self-lubricating material 261A-1. The metal core 260A-1 may be stainless steel, and the self-lubricating material 261A-1 may be POM. A stainless steel carriage 252A-1 slides on the linear rail such that the sliding interfaces are composed of a stainless steel surface against a self-lubricating material surface. In FIG. 2A-2, a similar configuration is shown, except that the rail 260A-2 is stainless steel with no self-lubricating material layers. Instead, carriage 252A-2, which may be may of stainless steel, has self-lubricating material layers 261A-2 disposed on interior surfaces thereof that face and contact the stainless steel rail 260A-2. Again, in this configuration, the sliding interfaces are composed of a stainless steel surface against a self-lubricating material surface. Any linear rail arrangements in which the sliding surfaces are stainless steel against a self-lubricating materials such as POM are contemplated.

FIGS. 2B-1 and 2B-2 schematically show linear rail arrangements in which stainless steel rail 260B-1 and 260B-2, respectively, has slots running the length of the top and bottom surfaces thereof. In FIG. 2B-1, strips 261B-1 of self-lubricating material like POM are sandwich bound in a metal bracket using insert molding. The self-lubricating strips 261B-2 are used for the bearing. The self-lubricating bearing can be at the same level with the steel bracket. In FIG. 2B-2, layers 261B-2 of self-lubricating material like POM can be press fitted into the slots of the rail 260B-2 to form a rail that can be used in a configuration such as shown in FIG. 2A-1.

FIG. 2C-1 schematically depicts a cross-sectional view of a rail showing that strips of self-lubricating material 261C-1 can be sandwich bound in a protruding fashion from steel rail 260C-1. FIG. 2C-2 schematically depicts a similar view of a rail showing that strips of self-lubricating material 261C-2 can be sandwich bound in a recessed fashion from steel rail 260C-2. A recessed bearing may be used to trap particles that can potentially be generated during the sliding operations.

In each of these various designs and configurations, the carriage slider and/or the rail is made of stainless steel, and the opposing surfaces are configured such that the interface is composed of steel on one surface and a self-lubricating engineering plastic on the other. As described, the self-lubricating engineering plastic may be POM, Nylon, PEEK, or combinations thereof. POM is an engineering thermoplastic used in precision parts requiring high stiffness, low friction, high chemical and mechanical stability and low moisture absorption. POM also has suitable fatigue strength for high repetition applications, as well as excellent machinability. Nylon and PEEK are other self-lubricating engineering polymers that can be used for the bearing raceway. The self-lubricating engineering plastics may include additives such as solid lubricants to further enhance the lubricity to thereby further reduce friction and wear. Solid lubricant additives include graphite, molybdenum disulfide, polytetrafluoroethylene (PTFE), zinc oxide, and combinations thereof. For the stainless steel of the rails and carriages, austenitic stainless steel (303, 304, 316, 310 and 321 grades) can be used. For various metal inserts for the bearing, austenitic 300 or 200 series stainless steel can be used, as well as ferritic or martensitic 400 series stainless steel. Additives including solid lubricants can be added to the stainless steel to further enhance the lubricity to help reduce friction and improve wear resistance. The solid lubricant additives can be graphite, molybdenum disulfide, polytetrafluoroethylene (PTFE), zinc oxide and combinations thereof.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of this disclosure are described as being performed by a single module or unit for purposes of clarity, it should be understood that the techniques of this disclosure may be performed by a combination of units or modules.

In one or more examples, the described techniques may be implemented in hardware, software, firmware, or any combination thereof. If implemented in software, the functions may be stored as one or more instructions or code on a computer-readable medium and executed by a hardware-based processing unit. Computer-readable media may include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a computer).

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor” as used herein may refer to any of the foregoing structure or any other physical structure suitable for implementation of the described techniques. Also, the techniques could be fully implemented in one or more circuits or logic elements.

All scientific and technical terms used herein have meanings commonly used in the art unless otherwise specified. The definitions provided herein are to facilitate understanding of certain terms used frequently herein and are not meant to limit the scope of the present disclosure.

As used herein, the phrases “at least one of” and “one or more of” followed by a list of elements refers to one or more of any of the elements listed or any combination of one or more of the elements listed.

As used herein, the terms “coupled” or “connected” refer to at least two elements being attached to each other either directly or indirectly. An indirect coupling may include one or more other elements between the at least two elements being attached. Further, in one or more embodiments, one element “on” another element may be directly or indirectly on and may include intermediate components or layers therebetween. Either term may be modified by “operatively” and “operably,” which may be used interchangeably, to describe that the coupling or connection is configured to allow the components to interact to carry out described or otherwise known functionality. For example, a controller may be operably coupled to a resistive heating element to allow the controller to provide an electrical current to the heating element.

As used herein, any term related to position or orientation, such as “proximal,” “distal,” “end,” “outer,” “inner,” and the like, refers to a relative position and does not limit the absolute orientation of an embodiment unless its context of usage clearly dictates otherwise.

As used herein, the term “configured to” may be used interchangeably with the terms “adapted to” or “structured to” unless the content of this disclosure clearly dictates otherwise.

The singular forms “a,” “an,” and “the” encompass embodiments having plural referents unless its context clearly dictates otherwise.

As used herein, “have,” “having,” “include,” “including,” “comprise,” “comprising” or the like are used in their open-ended sense, and generally mean “including, but not limited to.” It will be understood that “consisting essentially of,” “consisting of,” and the like are subsumed in “comprising,” and the like.

Reference to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout are not necessarily referring to the same embodiment of the disclosure.

Furthermore, the particular features, configurations, compositions, or characteristics may be combined in any suitable manner in one or more embodiments.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure.

1. A hard disk drive for recording data on a spinning magnetic media disk using a recording head suspended on the end of an actuator arm, the hard disk drive comprising:
a plain bearing linear rail system including a carriage slidably movable on a linear rail, thereby forming at least one sliding interface between the carriage and the linear rail, wherein the at least one sliding interface comprises a self-lubricating polymer surface in sliding contact with a stainless steel surface,
wherein the actuator arm is coupled to the carriage such that movement of the carriage along the linear rail moves the actuator arm in a linear fashion.

2. The hard disk drive of claim 1, wherein the self-lubricating polymer is POM, Nylon, PEEK, or combinations thereof.

3. The hard disk drive of claim 1, wherein the self-lubricating polymer includes a solid lubricant additive.

4. The hard disk drive of claim 3, wherein the solid lubricant additive is graphite, molybdenum disulfide, polytetrafluoroethylene, zinc oxide, or combinations thereof.

5. The hard disk drive of claim 1, wherein the stainless steel includes a solid lubricant additive.

6. The hard disk drive of claim 5, wherein the solid lubricant additive is graphite, molybdenum disulfide, polytetrafluoroethylene, zinc oxide, or combinations thereof.

7. The hard disk drive of claim 1, wherein the self-lubricating polymer surface is provided on the linear rail, and the stainless steel surface is provided on the carriage.

8. The hard disk drive of claim 1, wherein the self-lubricating polymer surface is provided on the carriage, and the stainless steel surface is provided on the linear rail.

9. The hard disk drive of claim 1, wherein the plain bearing linear rail system further includes a motor configured to move the carriage along the linear rail.

10. The hard disk drive of claim 9, wherein the motor is a voice coil motor, a piezoelectric motor, or an ultrasonic motor.

11. The hard disk drive of claim 1, wherein the plain bearing linear rail system further includes one or more positional feedback sensors.

12. The hard disk drive of claim 1, further comprising a sealed enclosure.

13. The hard disk drive of claim 1, wherein the plain bearing linear rail system is devoid of grease or other organic lubricants.

14. (canceled)

15. A linear actuator comprising:
a plain bearing linear rail system including a carriage slidably movable on a linear rail, thereby forming at least one sliding interface between the carriage and the linear rail, wherein the at least one sliding interface comprises a self-lubricating polymer surface in sliding contact with a stainless steel surface; and
a motor configured to move the carriage along the linear rail.

16. The linear actuator of claim 15, wherein the self-lubricating polymer is POM, Nylon, PEEK, or combinations thereof.

17. The linear actuator of claim 15, wherein the self-lubricating polymer includes a solid lubricant additive.

18. The linear actuator of claim 15, wherein the stainless steel includes a solid lubricant additive.

19. The linear actuator of claim 15, wherein the motor is a voice coil motor, a piezoelectric motor, or an ultrasonic motor.

20. The linear actuator of claim 15, further comprising one or more positional feedback sensors.
